(19) United States
(12) Patent Application Publication
(10) Pub. No.: US 2025/0276464 A1
(43) Pub. Date: Sep. 4, 2025

(54) SLICER FOR ITEMS AND METHOD OF MANUFACTURING AND USING THE SAME

(71) Applicant: BonTek, LLC, East Orleans, MA (US)

(72) Inventors: Michael Shabazian, East Orleans, MA (US); John Porter, Epping, NH (US)

(21) Appl. No.: 19/066,090

(22) Filed: Feb. 27, 2025

Related U.S. Application Data
(60) Provisional application No. 63/559,855, filed on Feb. 29, 2024.
(60) Provisional application No. 63/691,546, filed on Sep. 6, 2024.

(51) Int. Cl. B26D 3/30; B26B 29/06; B26D 7/02

(52) U.S. Cl. CPC B26D 3/30; B26B 29/063; B26D 7/02; B26B 2029/066; B26D 2210/06

(57) ABSTRACT

Devices and methods are provided for slicing an item such as a bagel. An apparatus includes an upper assembly with a blade and interior vertical rails, and a lower assembly with a holding plate, movable centering plates, and exterior vertical rails with a slot for an external cutting device. The lower assembly also includes a cam mechanism to activate the centering plates. A method involves depressing actuators to separate the centering plates, creating space for a food item. When the food item is placed on the holding plate, the actuators are released, applying equal force to center the food item. The device also includes a centering device and an actuator that, upon receiving force, engages the centering device to hold the item in a cutting position for the blade. The device cuts the item within about +/−one-sixteenth of an inch.

### CROSS-REFERENCE TO RELATED APPLICATIONS

This nonprovisional application claims the benefit of priority to U.S. Provisional Patent Application No. 63/559,855, titled “SLICER FOR ITEMS AND METHOD OF MANUFACTURING AND USING THE SAME,” filed Feb. 29, 2024, and U.S. Provisional Patent Application No. 63/691,546, titled “BLADE FOR SLICER FOR ITEMS,” filed Sep. 6, 2024, the disclosures of which are hereby incorporated by reference herein in their entireties.

### FIELD OF THE INVENTION

The present disclosure relates to a device for accurately, precisely, safely, adjustably, evenly, conveniently, and easily slicing an item, including a food item, such as a bagel, an English muffin, and the like.

### SUMMARY

Devices used for slicing food items (e.g., bagels, English muffins, and the like) exist in a variety of forms that allow a user to bisect a food item to a degree of accuracy and precision. In some approaches, the cutting device may be handheld, in which case the user holds the device in one hand, with the food item in the other hand, and proceeds to insert the cutting device into the food item, while concurrently rotating the food item, to bisect the food item into halves. This approach, however, lacks precision due to the quality of the cut being susceptible to human error and increases the risk of self-inflicted injury by the user.

In some approaches, the cutting device may include a non-dynamic housing the user places the food item in as well as a blade that fits into the housing such that, when forced down by the user, the blade bisects the food item in a guillotine-like fashion. This approach also lacks precision because not every food item placed in the housing fits inside of it perfectly, so the housing's inability to adjust its width to fit, secure, and center the food item prevents an even cut when the user presses down the blade. In addition, the guillotine-like cutting device may fail to include any safety measures (e.g., a protective plate) that guard the blade from potentially injuring the user. Also, with such approach, the blade may not include a serrated design, which is relatively less effective, and the relatively large size of the guillotine-like cutting device may be inconvenient for the user who wishes to stow away the cutting device in a drawer or cabinet.

In some approaches, a young child may get ahold of the top portion of the cutting device, including the blade, in which case they would be susceptible to cutting themself against the blade.

In some approaches, the cutting device may include a non-dynamic housing the user places the food item in as well as slots on both sides to allow the user to manually bisect the food item with a regular kitchen knife. This approach also lacks precision for the same reasons as the guillotine-like cutting device and some approaches can be cumbersome to use. The large and clunky size of the cutting device may be inconvenient for the user who wishes to stow away the cutting device in a drawer or cabinet. The aesthetics of the cutting device are not appealing to the modern, sophisticated consumer.

Thus, a need has arisen for improvement of devices for slicing items. Slicers are provided that improve accuracy, precision, safety (including child or elder safety and the like), adjustability, evenness, convenience, ease-of-use, aesthetics, and the like. Specifically, slicers are provided that address all of the foregoing in one device: (1) safety against self-inflicted injury, (2) a mechanism with the ability to center different-sized food items for even slicing, (3) the ability to use the included blade to slice through the food item for safety and convenience, (4) the ability to use a regular kitchen knife to slice through the food item if necessary due to the softness of the food item, (5) a form factor that can fit easily into a drawer or cabinet, and (6) an aesthetic that appeals to the modern, sophisticated consumer.

The present invention is not limited to the combination of the elements as listed herein and may be assembled in any combination of the elements as described herein.

These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings, in which like reference numerals indicate identical or functionally similar elements, of which:

FIG. 1A shows an exploded view of a bagel slicing device, in accordance with some embodiments of the disclosure;

FIG. 1B shows an exterior perspective view of a lower assembly of a bagel slicing device (inverted), in accordance with some embodiments of the disclosure;

FIG. 2A shows a side section view of an engaged bagel slicing device, in accordance with some embodiments of the disclosure;

FIG. 2B shows a perspective view of the engaged bagel slicing device, in accordance with some embodiments of the disclosure;

FIG. 3 shows a perspective view of a disengaged bagel slicing device, in accordance with some embodiments of the disclosure;

FIG. 4 shows a side section view of an engaged bagel slicing device, in accordance with some embodiments of the disclosure;

FIG. 5A shows a perspective view of a disengaged bagel slicing device, in accordance with some embodiments of the disclosure;

FIG. 5B shows a top section view of the disengaged bagel slicing device, in accordance with some embodiments of the disclosure;

FIG. 6A shows a perspective view of an engaged bagel slicing device, in accordance with some embodiments of the disclosure;

FIG. 6B shows a top section view of the engaged bagel slicing device, in accordance with some embodiments of the disclosure;

FIG. 7A shows another perspective view of an engaged bagel slicing device, in accordance with some embodiments of the disclosure;

FIG. 7B shows a top section view of the engaged bagel slicing device, in accordance with some embodiments of the disclosure;

FIG. 8A shows a perspective view of a disengaged bagel slicing device, in accordance with some embodiments of the disclosure;

FIG. 8B shows a perspective view of a partially engaged bagel slicing device, in accordance with some embodiments of the disclosure;

FIG. 8C shows a perspective view of a fully engaged bagel slicing device, in accordance with some embodiments of the disclosure;

FIG. 9 shows a blade design with a serrated edge for bisecting a food item within the lower assembly of the bagel slicing device, in accordance with some embodiments of the disclosure;

FIG. 10 shows a perspective view of a lower assembly of a disengaged bagel slicing device, in accordance with some embodiments of the disclosure;

FIG. 11 shows another perspective view of a lower assembly of an engaged bagel slicing device, in accordance with some embodiments of the disclosure;

FIG. 12 shows an enhanced blade design for bisecting a food item within the lower assembly of the bagel slicing device, in accordance with some embodiments of the disclosure; and

FIG. 13 shows a more detailed view of FIG. 12.

The drawings are intended to depict only typical aspects of the subject matter disclosed herein, and therefore should not be considered as limiting the scope of the disclosure. Those skilled in the art will understand that the structures, devices, and methods specifically described herein and illustrated in the accompanying drawings are non-limiting embodiments and that the scope of the present invention is defined solely by the claims.

### DETAILED DESCRIPTION

An apparatus designed for cutting food items is provided. In some embodiments, the apparatus consists of two main parts: an upper assembly and a lower assembly. The upper assembly has interior vertical rails and a blade attached within these rails. The lower assembly, which can be separated from the upper assembly, includes several components as follows: a holding plate to support a food item; movable centering plates that secure the food item in the center of the lower assembly to ensure an even cut when the upper assembly comes down; exterior vertical rails with a slot down the center to accommodate an external cutting device; and a cam mechanism that activates the movable centering plates.

When no food item is in the lower assembly, the centering plates are in a default closed position. The lower assembly also has one or more actuators. When these are pressed, the centering plates separate to create space for the food item.

Once the food item is placed on the holding plate between the centering plates, releasing the actuators causes the centering plates to apply equal force on the food item, centering it. A spring mechanism keeps the centering plates in their default closed position.

The lower assembly also includes a set of pins that connect the centering plates to inner and outer plates within the assembly. These pins move within channels in the inner and outer plates, allowing the centering plates to move when the actuators are pressed or released.

When a user presses the actuators, they move up and down vertical slides of the outer plates and connect to linkage bars. These bars are connected to the cam mechanism, which activates the centering plates.

The lower assembly's exterior vertical rails are designed to engage with the upper assembly's rails. This allows the blade in the upper assembly to follow a slicing path that bisects the food item when the two assemblies engage.

The lower assembly also has at least one slot to receive an external cutting tool and guide its cutting motion. The movable centering plates are designed to align the food item within a margin of error of about +/−one-sixteenth of an inch (about +/−0.16 centimeter).

In some embodiments, a method is provided for using an apparatus designed for cutting food items, and a device that includes the apparatus. The method involves an apparatus with an upper assembly (with interior vertical rails and a blade) and a lower assembly (with a holding plate, movable centering plates, exterior vertical rails with a slot for an external cutting device, and a cam mechanism to activate the centering plates).

The method includes the following steps: depress one or more actuators to separate the centering plates within the lower assembly, creating space for a food item; place the food item on the holding plate between the centering plates; and release the actuators to apply equal force on the food item, centering it.

The lower assembly also includes pins that couple the centering plates to a set of inner and outer plates. When the actuators are depressed or released, these pins move within channels in the inner and outer plates, allowing the centering plates to move. The actuators connect to linkage bars and the cam mechanism, activating the centering plates.

The movement of the centering plates involves the pins moving along slanted channels in the inner plates; the outer plates moving along the inner plates via vertical slide alignments; and the pins moving along horizontal channels in the outer plates.

A spring mechanism keeps the centering plates in their default closed position. The lower assembly also has a slot to receive an external cutting tool and guide its cutting motion. The centering plates are designed to align the food item within a margin of error of about +/−one-sixteenth of an inch (about +/−0.16 centimeter).

The device includes an upper assembly and a lower assembly for an item. It has a movable blade (via the upper assembly), a movable holding plate (via the lower assembly) to hold the item, a centering device to hold and secure the item, a cam mechanism to activate the centering plates, and an actuator to engage the centering device and hold the item in a cutting position for the blade. The device also includes a spring mechanism to hold the centering plates at a minimum distance apart, and pins to connect the centering plates to the upper or lower assembly and allow movement of the centering plates. The device has a guidance mechanism that is connected to the lower assembly. This mechanism allows the blade to cut the food item.

The centering device in the apparatus is designed to secure the food item in a position that is approximately in the center of the device. This facilitates an even cut or bisection of the food item. The centering device is also designed to align the food item within a margin of error of about +/−one-sixteenth of an inch (about +/−0.16 centimeter). This ensures that the food item is positioned accurately for cutting.

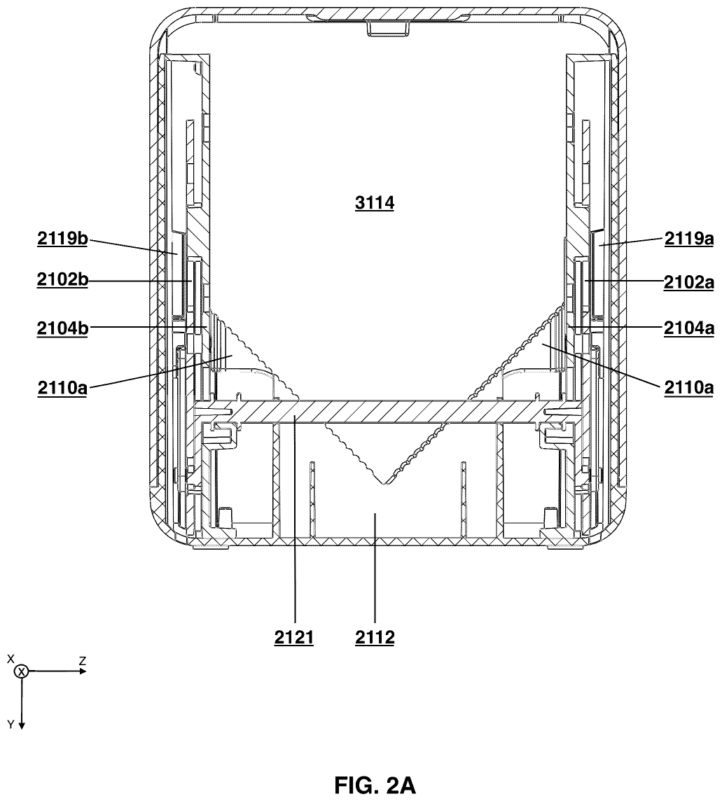

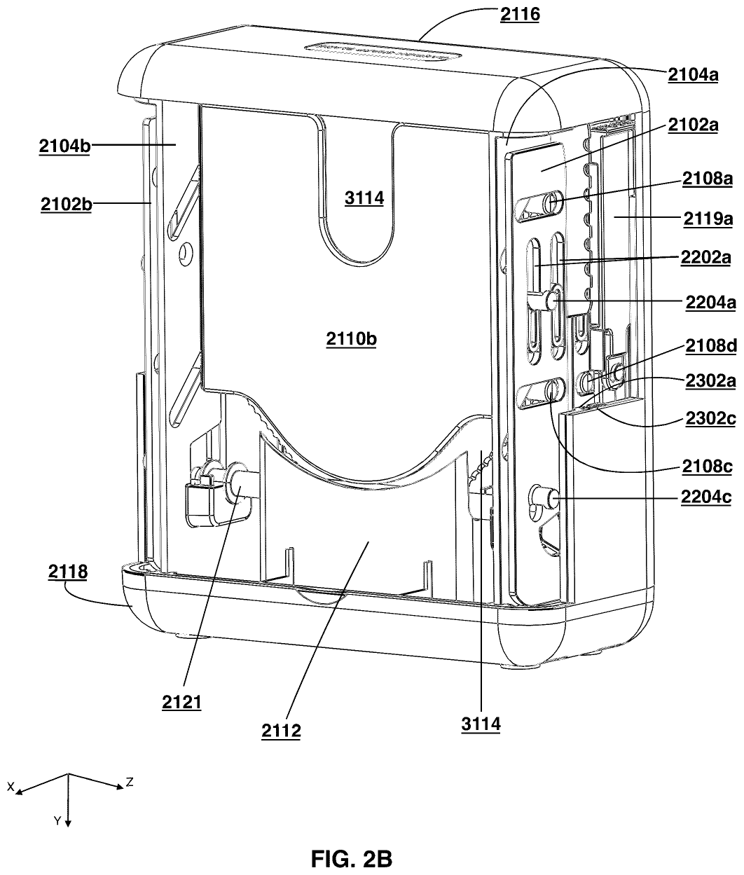

An apparatus is described herein, where the apparatus includes an upper assembly, which further includes an upper interior portion and a blade affixed to the upper interior portion. In some embodiments, the apparatus includes a lower assembly, separable from the upper assembly, which further includes a holding plate configured to support a food item when placed within the lower assembly and movable centering plates configured to secure the food item in a position that lies substantially in the center of the lower assembly to facilitate a substantially even bisection of the food item when the upper assembly engages with the lower assembly. It will be understood that a food item “substantially in the center” of the lower assembly, as described herein, means the food item is aligned along a y-z plane of the lower assembly congruent with the center of a nest of the holding plate. The nest may have any suitable shape. In some embodiments, the nest has a curved shape; in other embodiments, the nest has a V-shape. In some embodiments, the alignment of the food item may include an about +/−one-sixteenth of an inch (about +/−0.16 centimeter) margin of error. Consequently, the “substantially even bisection of the food item” may be susceptible to a +/−one-sixteenth of an inch (about +/−0.16 centimeter) margin of error. In some embodiments, the centering plates may be configured in a default closed position when the upper assembly is disengaged from the lower assembly. It will be understood, however, that the lower assembly may further include one or more actuators that, when depressed, cause the centering plates to separate from each other to make room for (i.e., define a space for) the food item. In some embodiments, in response to the food item being placed on the holding plate between the centering plates, releasing the one or more actuators may cause the centering plates to apply substantially similar amounts of force (e.g., along an x-y plane of the lower assembly) on the food item to substantially center the food item. In some embodiments, a spring mechanism may retain the default closed position of the centering plates at a minimum distance (e.g., about 0.7 inch (about 1.778 centimeters)) from each other. For example, two vertical extension springs that load the outer plates, also attached to the inner plates, convert the vertical spring energy to horizontal energy through horizontal channels to slanted channels to compress the centering plates. See, e.g., FIG. 2B that shows an example of where the extension springs attach to the inner and outer plates. It will be understood that the centering plates have a range between them from about 0.7 inch (about 1.778 centimeters) to about 2.3 inches (about 5.842 centimeters) when the device is in a clamped or engaged position (i.e., when the centering plates are engaged with the held item). In some embodiments, in a “thin” version of the device, the centering plates have a range between them of about 0.125 inch (about 0.32 centimeters) (or any suitable range) in a clamped or engaged position, which is suited for holding and cutting relatively thin items.

In some embodiments, the lower assembly may further include a plurality of pins configured to couple the centering plates to a set of outer plates and a set of inner plates within the lower assembly such that each of the plurality of pins resides within corresponding channels of the set of outer plates and the set of inner plates that facilitates movement of the centering plates when one or more actuators is depressed or released. In some embodiments, the movement of the centering plates may include a movement of the plurality of pins along slanted channels of the set of inner plates, a movement of the set of outer plates along the set of inner plates, via exterior verticals rails, and a movement of the plurality of pins along horizontal channels of the set of outer plates. It will be understood that each of the plurality of pins has a diameter of about ¼-inch (about 0.635 centimeter). In some embodiments, the lower assembly may further include exterior vertical rails such that the blade is configured to engage with the exterior vertical rails in the lower assembly and follow a slicing path that bisects the food item when the upper assembly engages with the lower assembly. In some embodiments, the apparatus may further include a safety mechanism (e.g., a guard) positioned at the bottom of the upper assembly, where the blade slides through an opening in the safety mechanism when the upper assembly engages with the lower assembly. It will be understood that the blade is mounted solidly to an upper interior portion of the upper assembly, and the safety mechanism (e.g., guard) moves on pins and springs in the z-axis direction as the upper assembly is pushed towards the bottom assembly.

In some embodiments, the holding plate may include a nest that contributes to holding and centering the food item within the lower assembly. In some embodiments, the apparatus may further include an opening along the perimeter of the upper assembly to enable cleaning of the blade, and the lower assembly will have a cosmetic cover that will hide the clamping mechanism (e.g., the centering plates) and prevent any pinch points. It will be understood that the upper assembly and the lower assembly may be comprised of any suitable plastic (e.g., polycarbonate, acetal, and the like), metal, or alloy (e.g., stainless steel). It will also be understood that the blade may include a variety of serrated edge designs, one of which may include an about 33° to about 45° knife edge. It will be understood that the serrated edge design is symmetrical.

A method is disclosed herein, where the method includes depressing one or more actuators such that centering plates separate from each other within a lower assembly to make room for a food item and, in response to the food item being placed on a holding plate between the centering plates, releasing the one or more actuators to apply substantially similar amounts of force on the food item to substantially center the food item. In some embodiments, the lower assembly further includes a plurality of pins configured to couple the centering plates to a set of outer plates and a set of inner plates within the lower assembly such that each of the plurality of pins resides within corresponding channels of the set of outer plates and the set of inner plates that facilitates movement of the centering plates when the one or more actuators is depressed or released. In some embodiments, the movement of the centering plates may include a movement of the plurality of pins along slanted channels of the set of inner plates, a movement of the set of outer plates along the set of inner plates, via vertical slide alignments, and a movement of the plurality of pins along horizontal channels of the set of outer plates. It will be understood that a spring mechanism may retain a default closed position of the centering plates at a minimum distance from each other.

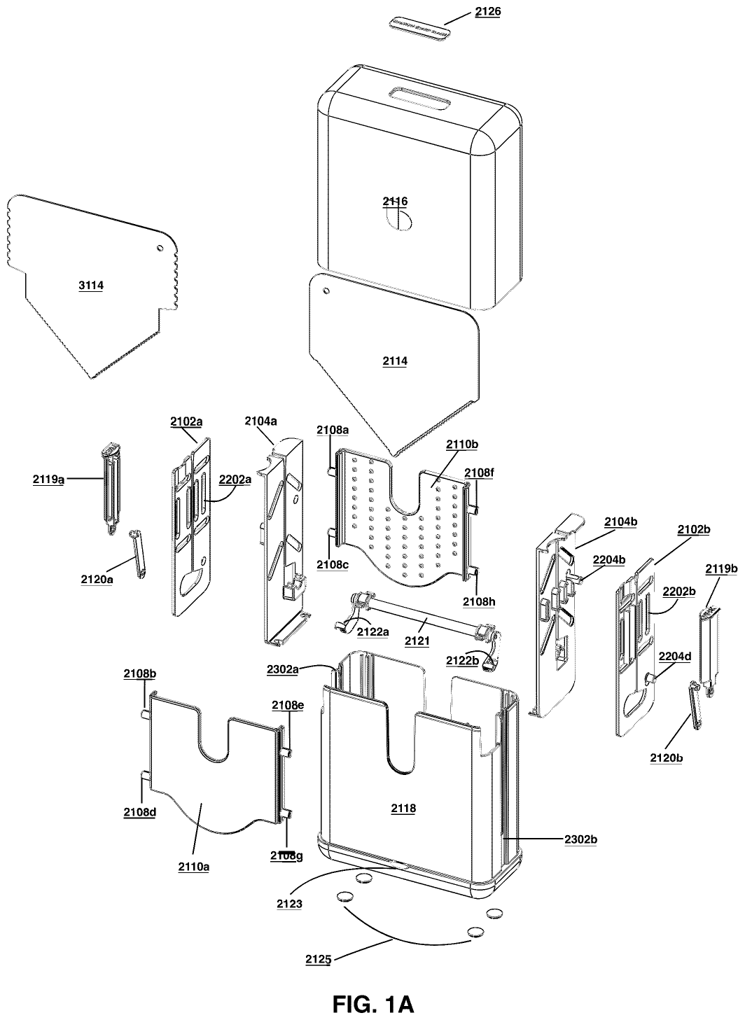

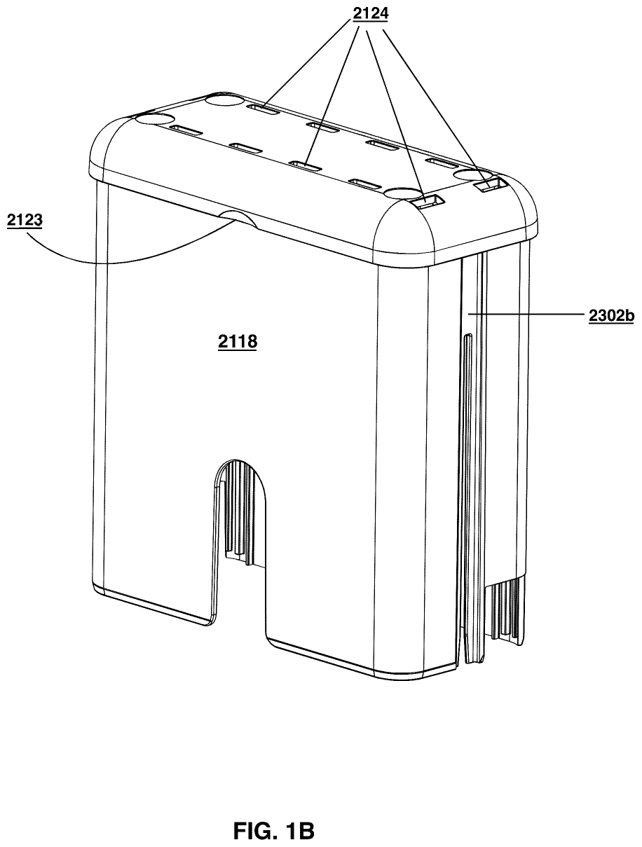

FIGS. 1A-13 show a bagel slicing device, in accordance with some embodiments of the present disclosure. An apparatus is described herein, where the apparatus includes an upper assembly, which further includes interior vertical rails and a blade affixed to the upper assembly within the interior vertical rails. In some embodiments, the apparatus includes a lower assembly, separable from the upper assembly, which further includes a holding plate configured to support a food item when placed within the lower assembly and movable centering plates configured to secure the food item in a position that lies substantially in the center of the lower assembly to facilitate a substantially even bisection of the food item when the upper assembly engages with the lower assembly. It will be understood that a food item “substantially in the center” of the lower assembly, as described herein, means the food item is aligned along a y-z plane of the lower assembly congruent with the center of a curved nest of the holding plate. In some embodiments, the alignment of the food item may include a +/−one-sixteenth of an inch (about +/−0.16 centimeter) margin of error. Consequently, the “substantially even bisection of the food item” may be susceptible to a +/−one-sixteenth of an inch (about +/−0.16 centimeter) margin of error. In some embodiments, the centering plates may be configured in a default closed position when the upper assembly is disengaged from the lower assembly. It will be understood, however, that the lower assembly may further include one or more actuators that, when depressed, cause the centering plates to separate from each other to make room for the food item. In some embodiments, in response to the food item being placed on the holding plate between the centering plates, releasing the one or more actuators may cause the centering plates to apply substantially similar amounts of force (e.g., along an x-y plane of the lower assembly) on the food item to substantially center the food item. In some embodiments, a spring mechanism may retain the default closed position of the centering plates at a minimum distance (e.g., about 0.7 inch (about 1.778 centimeters)) from each other. It will be understood that the centering plates have a range between them from about 0.7 inch (about 1.778 centimeters) to about 2.3 inches (about 5.842 centimeters).

In some embodiments, the lower assembly may further include a plurality of pins configured to couple the centering plates to a set of inner plates and outer plates within the lower assembly such that each of the plurality of pins resides within corresponding channels of the set of inner plates and the outer plates that facilitate movement of the centering plates when one or more actuators is depressed or released. In some embodiments, the movement of the centering plates may include a movement of the plurality of pins along slanted channels of the set of inner plates, a movement of the outer plates along the corresponding inner plates, via vertical slide alignments, and a movement of the corresponding plurality of pins along horizontal channels of the outer plate. It will be understood that each of the plurality of pins has a diameter of about ¼-inch (about 0.635 centimeter). In some embodiments, the lower assembly may further include exterior vertical rails such that the interior vertical rails of the upper assembly are configured to engage with the exterior vertical rails of the lower assembly and the blade in the upper assembly will follow a slicing path that bisects the food item when the upper assembly engages with the lower assembly. In some embodiments, the lower assembly may further include a vertical slot down the center of the exterior vertical rails configured to receive a regular kitchen knife for slicing food items without the use of the upper assembly.

In some embodiments, the holding plate may include a curved nest that contributes to holding and centering the food item within the lower assembly. It will be understood that the upper assembly and the lower assembly may be comprised of any suitable plastic (e.g., polycarbonate, acetal, and the like), metal, or alloy (e.g., stainless steel). It will also be understood that the blade may include a variety of serrated edge designs, one of which may include an about 33° to about 45° knife edge. It will be understood that the serrated edge design is symmetrical.

A method is disclosed herein, where the method includes depressing one or more actuators such that centering plates separate from each other within a lower assembly to make room for a food item and, in response to the food item being placed on a holding plate between the centering plates, releasing the one or more actuators to apply substantially similar amounts of force on the food item to substantially center the food item. In some embodiments, the lower assembly further includes a plurality of pins configured to couple the centering plates to a set of inner plates and outer plates within the lower assembly such that each of the plurality of pins resides within corresponding channels of the set of inner plates and the outer plates that facilitate movement of the centering plates when the one or more actuators is depressed or released. In some embodiments, the movement of the centering plates may include a movement of the plurality of pins along slanted channels of the set of inner plates, a movement of the outer plates along the corresponding inner plates, via vertical slide alignments, and a movement of the corresponding plurality of pins along horizontal channels of the outer plates. It will be understood that a spring mechanism may retain a default closed position of the centering plates at a minimum distance from each other.

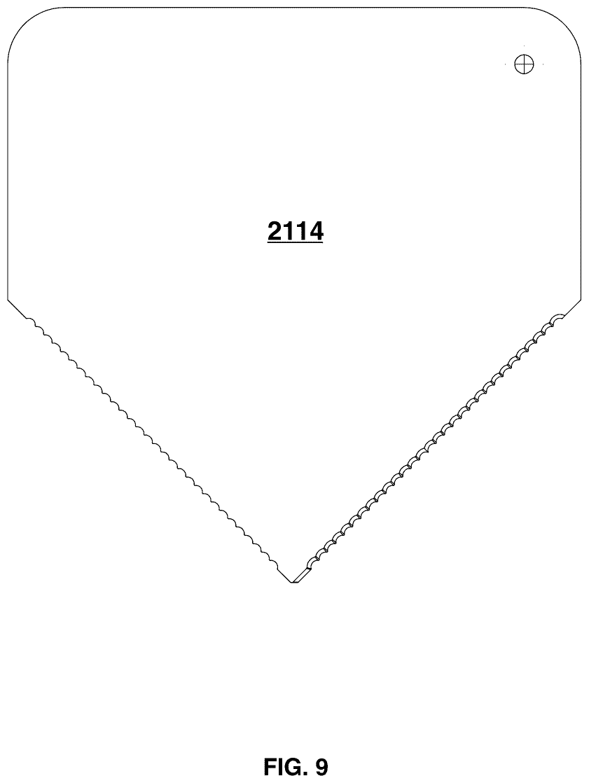

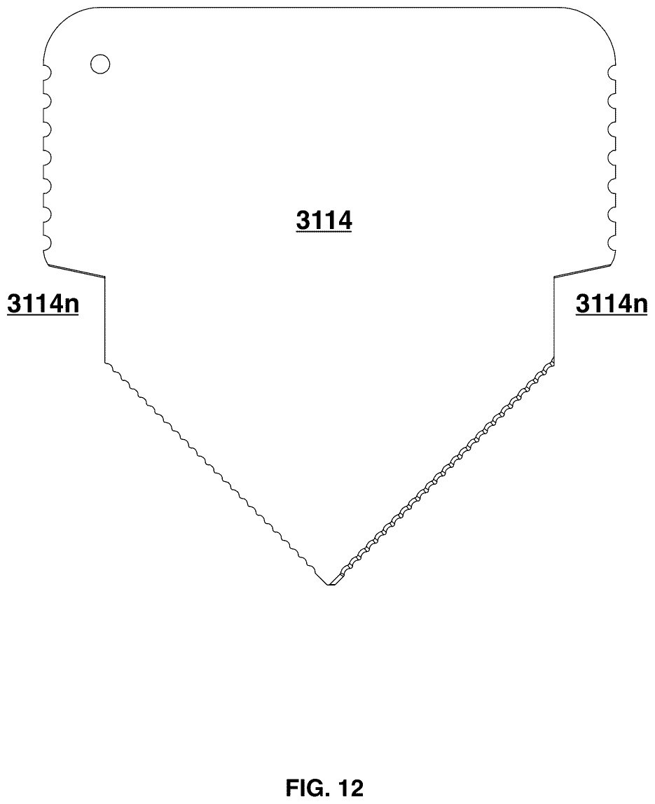

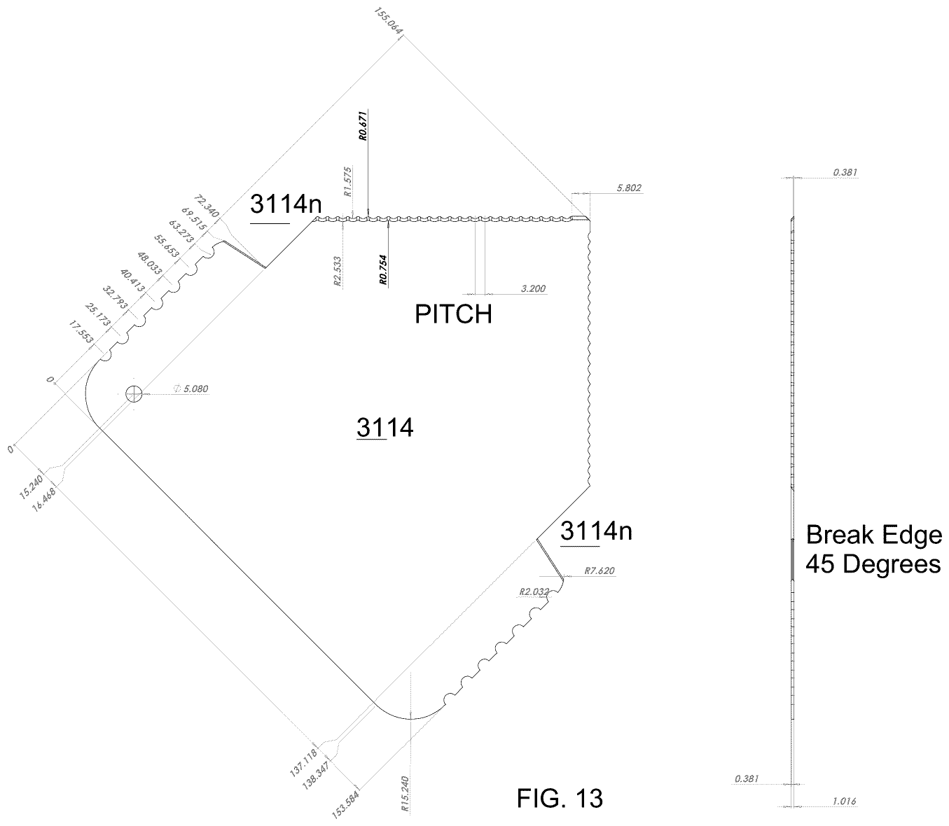

FIG. 1A shows an exploded view of a bagel slicing device, in accordance with some embodiments of the present disclosure, while FIG. 1B shows an exterior perspective view of a lower assembly of a bagel slicing device (inverted), in accordance with some embodiments of the disclosure. FIG. 1A illustrates a lower assembly 2118, an upper assembly 2116, a left-hand outer plate 2102a, a right-hand outer plate 2102b, a left-hand inner plate 2104a, a right-hand inner plate 2104b, a centering plate 2110a, a centering plate 2110b, a blade 2114, an enhanced blade 3114, a left-hand actuator 2119a, a right-hand actuator 2119b, a left-hand short linkage bar 2120a, a right-hand short linkage bar 2120b, a camshaft 2121, a left-hand cam 2122a, and a right-hand cam 2122b. The terms left-hand and right-hand are exemplary and somewhat arbitrary depending on viewpoint, and the device can be assembled in any suitable orientation for achieving the disclosed functionality. FIG. 1B illustrates a lower assembly 2118 (inverted) with air vents 2124, thumb groove 2123, and exterior vertical rail 2302b with a vertical slot down the center configured to receive an external cutting device. FIGS. 2A-8C, 10-11 illustrate various cross-sections and views of the assembled device. FIG. 9 illustrates the blade 2114. FIGS. 12-13 illustrate the enhanced blade 3114.

In some embodiments, in response to a user depressing one or more actuators 2119a, 2119b, the actuators 2119a, 2119b move up and down on vertical slides 2202a, 2202b and connect to short linkage bars 2120a, 2120b, that in turn are connected to camshaft 2121 and cams 2122a, 2122b that connect both sets of inner plates 2104a, 2104b and outer plates 2102a, 2102b to activate the centering plates 2110a, 2110b. In some embodiments, Delrin®, a semi-crystalline engineering-grade thermoplastic, is used. In some embodiments, 30% Glass-filled nylon, a synthetic polyamide thermoplastic, is used. In some embodiments, Acrylonitrile butadiene styrene is used.

In some embodiments, thumb grooves 2123 are provided to facilitate separating the upper assembly 2116 from the lower assembly 2118. In some embodiments, air vents 2124 are provided to solve a potential vacuum caused when the two assemblies are fitted together. In some embodiments, anti-skid pads 2125 are provided. In some embodiments, a cover 2126 is provided. The cover 2126 may include a warning message, such as “CAUTION SHARP BLADE” or the like.

Outer plates 2102a, 2102b are located on the immediate exterior surface of inner plates 2104a, 2104b, respectively, within lower assembly 2118 such that outer plates 2102a, 2102b fit and slide along the back of inner plates 2104a, 2104b, respectively, via vertical slide alignments 2202a, 2202b, resulting in the alignment of horizontal channels of outer plates 2102a, 2102b with slanted channels of inner plates 2104a, 2104b. Outer plates 2102a, 2102b, including horizontal channels, couple to inner plates 2104a, 2104b, including slanted channels, via pins 2108a-2108h extending through the slanted channels of inner plates 2104a, 2104b to the horizontal channels of outer plates 2102a, 2102b to securely fasten the plates together. In some embodiments, outer plates 2102a, 2102b may include any suitable number of horizontal channels that equals the number of slanted channels of inner plates 2104a, 2104b and the number of pins 2108a-2108h extending therethrough. Inner plates 2104a, 2104b are located on the immediate interior surface of outer plates 2102a, 2102b within lower assembly 2118 such that outer plates 2102a, 2102b fit and slide along the back of inner plates 2104a, 2104b, via vertical slide alignments 2202a, 2202b. As described above, vertical slide alignments 2202a, 2202b allow slanted channels of inner plates 2104a, 2104b to align with horizontal channels of outer plates 2102a, 2102b, which enables pins 2108a-2108h to extend through inner plates 2104a, 2104b and outer plates 2102a, 2102b to securely fasten the plates together. That is, in some embodiments, the inner plates 2104a, 2104b are not statically coupled with the outer plates 2102a, 2102b. Lower assembly 2118 includes exterior vertical rails 2302a, 2302b, which guide upper assembly 2116, including blade 2114, along a slicing path (e.g., a y-axis) towards the center of holding plate 2112 (not visible in FIG. 1A) when upper assembly 2116 engages with lower assembly 2118. In some embodiments, inner plates 2104a, 2104b may include any suitable number of slanted channels that equals the number of horizontal channels of outer plates 2102a, 2102b and the number of pins 2108a-2108h extending therethrough. It will be understood that the slanted channels of inner plates 2104a, 2104b may be oriented at any suitable angle with respect to the horizontal channels of outer plates 2102a, 2102b. In some embodiments, the bagel slicing device may be used to bisect any suitable food item into equal halves.

Pins 2108a-2108h couple centering plates 2110a, 2110b to inner plates 2104a, 2104b and outer plates 2102a, 2102b by extending from the centering plates 2110a, 2110b through slanted channels of inner plates 2104a, 2104b and horizontal channels of outer plates 2102a, 2102b. A concurrent motion of pins 2108a-2108h and outer plates 2102a, 2102b determines the distance between centering plates 2110a, 2110b, which may be any distance between the range of about 0.7 inch (about 1.778 centimeters) and about 2.3 inches (about 5.842 centimeters) to securely fit and center a food item sitting on holding plate 2112. In some embodiments, a user may depress or release one or more actuators 2119a, 2119b to initiate the movement of centering plates 2110a, 2110b. Each of the plurality of pins 2108a-2108h moves along slanted channels of inner plates 2104a, 2104b and horizontal channels of outer plates 2102a, 2102b, while outer plates 2102a, 2102b shift along inner plates 2104a, 2014b, via vertical slide alignments 2202a, 2202b, to determine the distance between centering plates 2110a, 2110b. In some embodiments, lower assembly 2118 may include any suitable number of pins 2108a-2108h that equals the number of slanted channels of inner plates 2104a, 2104b and the number of horizontal channels of outer plates 2102a, 2102b. Centering plates 2110a, 2110b are located in lower assembly 2118 between inner plates 2104a, 2104b and above holding plate 2112. As described above, centering plates 2110a, 2110b mechanically connect to inner plates 2104a, 2104b and outer plates 2102a, 2102b via pins 2108a-2108h. In some embodiments, centering plates 2110a, 2110b may be configured in a default closed position and require a user to depress actuators to separate the centering plates 2110a, 2110b and make room for a food item. When a user places a food item (e.g., a bagel, an English muffin, and the like) on holding plate 2112 between centering plates 2110a, 2110b, the user may release the actuators to initiate a simultaneous movement of the plurality of pins 2108a-2108h and outer plates 2102a, 2102b, resulting in centering plates 2110a, 2110b converging along an x-y plane to secure the food item in a centered position such that blade 2114 may evenly bisect the food item when upper assembly 2116 engages with lower assembly 2118.

Holding plate 2112 (not visible in FIG. 1A) is located at a lower interior portion of lower assembly 2118 and includes a curved nest, which is where the food item rests until being bisected by blade 2114 or a kitchen knife. The device is configured in some embodiments, to include features that accommodate insertion of a kitchen knife. Alternatively, the device is configured in other embodiments, to exclude features that accommodate insertion of a kitchen knife so that the cutting is solely performed by the blade 2114. It will be understood that the curved nest of holding plate 2112 aligns with exterior vertical rails 2302a, 2302b of lower assembly 2118 such that upper assembly 2116, including blade 2114, follows a slicing path along the exterior vertical rails 2302a, 2302b of lower assembly 2118 to split the curved nest in half. Blade 2114 is affixed to upper assembly 2116 within the interior vertical rails 2302c, 2302d of upper assembly 2116 (not visible in FIG. 1A) and, when upper assembly 2116 engages with lower assembly 2118, follows a slicing path towards the curved nest of holding plate 2112. It will be understood that blade 2114 exists along a y-z plane of lower assembly 2118 congruent with the center of holding plate 2112. In some embodiments, a user may place a food item on the curved nest of holding plate 2112, in which case, depending on the width of the food item, the user may release actuators to center the food item with centering plates 2110a, 2110b along the y-z plane of lower assembly 2118 congruent with the center of holding plate 2112. Once the user determines the food item is centered, the user engages upper assembly 2116 with lower assembly 2118 such that blade 2114 evenly bisects the food item. In some embodiments, blade 2114 may include any suitable serrated design edge to optimally bisect the food item, one of which may include an about 33° to about 45° knife edge. It will be understood that the serrated edge design is symmetrical. In some embodiments, the dimensions of blade 2114 may be dependent on the package configuration of the bagel slicing device, so blade 2114 may be any suitable length, width, or height.

The blade 2114 is not limited to that illustrated in the drawings. In some embodiments, the blade 2114 includes at least one of a serrated cutting edge (e.g., a bread knife edge), a sharp cutting edge (e.g., a steak knife edge), an offset serrated cutting edge, a scalloped edge, a fully serrated edge, a partially serrated edge, a cutting edge with relatively smaller gullets, a cutting edge with relatively larger gullets, a cutting edge with a relatively greater number of points or teeth, a cutting edge with a relatively fewer number of points or teeth, a single bevel cutting edge, a chisel cutting edge, a double bevel cutting edge, combinations of the same, or the like. The cutting edge is disposed, in some embodiments, at any suitable angle, such as a substantially horizontal arrangement (not shown), such as between about 30 to 60 degrees with respect to the horizontal as shown in FIGS. 1A, 2A, 2B, 3, 5A, 6A, 7A, 8A, 8B, 8C, 9, 12, and 13, or so as to create a substantially non-linear cutting edge (not shown).

Upper assembly 2116 includes blade 2114 and interior vertical rails 2302c, 2302d (not visible in FIG. 1A). If a user engages upper assembly 2116 with lower assembly 2118, upper assembly 2116 encompasses a significant portion of the height of lower assembly 2118 such that blade 2114 slices a food item sitting in lower assembly 2118 completely. It will be understood that upper assembly 2116 may include additional components besides blade 2114 and interior vertical rails 2302c, 2302d. Lower assembly 2118 includes outer plates 2102a, 2102b, inner plates 2104a, 2104b, the plurality of pins 2108a-2108h, centering plates 2110a, 2110b, exterior vertical rails 2302a, 2302b, a vertical slot down the center of the exterior vertical rails, vertical slide alignments 2202a, 2202b, and holding plate 2112. Lower assembly 2118 receives upper assembly 2116, including blade 2114, such that the interior vertical rails of upper assembly 2116 engage with the exterior vertical rails of lower assembly 2118, and blade 2114 follows a slicing path, along the y-axis of lower assembly 2118, towards the center of holding plate 2112 to bisect a food item. In some embodiments, lower assembly 2118 may include additional components within its volume. The dimensions of the apparatus depicted in FIG. 1A are about 7.00 inches (about 17.78 centimeters) x about 6.25 inches (about 15.88 centimeters) x about 2.75 inches (about 6.985 centimeters). It will be understood that the dimensions of the bagel slicing device may be altered to any suitable configuration. Fasteners may be provided to join features of the device. For example, in some embodiments, thread inserts (e.g., SPRIOL No. 150526, made of brass) are provided to join the lower assembly 2118 with one or more other structures of the device. In some embodiments, screws will come through the bottom of lower assembly 2118 to join the lower assembly 2118 with one or more other structures of the device, and silicone anti-skid pads 2125 will cover the screws.

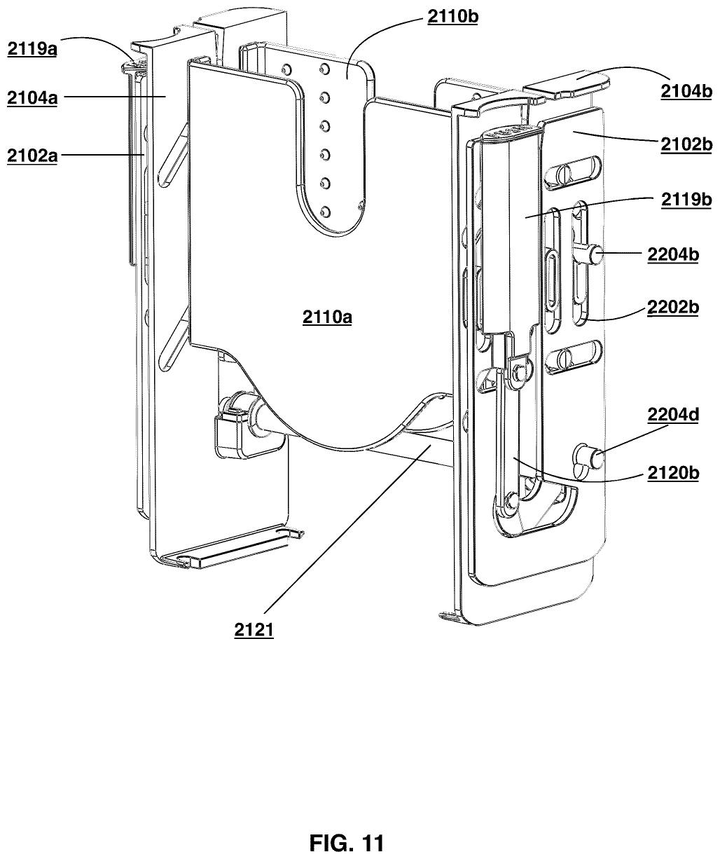

FIG. 2A shows a side section view of an engaged bagel slicing device along the device's y-z plane, in accordance with some embodiments of the present disclosure, while FIG. 2B shows a perspective view of the engaged bagel slicing device, in accordance with some embodiments of the present disclosure. FIG. 2A and FIG. 2B depict the configuration of outer plates 2102a, 2102b fitted on the exterior face of inner plates 2104a, 2104b. FIG. 2B includes vertical slide alignments 2202a, 2202b, which allow outer plates 2102a, 2102b, in response to a user depressing or releasing one or more actuators, to maneuver up and down the back of inner plates 2104a, 2104b. The depth at which blade 3114 reaches within lower assembly 2118 to ensure a complete, even bisection of a food item is portrayed by FIG. 2A and FIG. 2B as well. The perspective view in FIG. 2B shows how blade 3114 is affixed to upper assembly 2116, and how the interior vertical rails 2302c, 2302d of upper assembly 2116 fit into the exterior vertical rails 2302a, 2302b of lower assembly 2118 such that blade 3114 follows a slicing path towards the center of the curved nest of holding plate 2112. In FIG. 2B, a portion of the slanted channels of inner plates 2104a, 2104b are displayed, which show pins 2108a, 2108c, 2108d extending through inner plate 2104a and outer plate 2102a. Each of pins 2108a, 2108c, 2108d connect to centering plates 2110a, 2110b (not all visible in FIG. 2B), allowing centering plates 2110a, 2110b, in response to a user depressing or releasing one or more actuators, to move along the x-y plane of lower assembly 2118 to either separate or converge. The perspective view in FIG. 2B also shows the horizontal channels of outer plates 2102a, 2102b, which align with slanted channels of inner plates 2104a, 2104b due to the movability of outer plates 2102a, 2102b along the exterior face of inner plates 2104a, 2104b, via vertical slide alignments 2202a, 2202b. The perspective view in FIG. 2B also shows spring retention studs 2204a-2204d (not all visible in FIG. 2B) onto which vertical extension springs will attach. Spring retention studs 2204a, 2204b are part of inner plates 2104a, 2104b and extend through vertical slide alignments 2202a, 2202b in outer plates 2102a, 2102b. Spring retention studs 2204c, 2204d are part of outer plates 2102a, 2102b (best seen, e.g., in FIGS. 2B and 11).

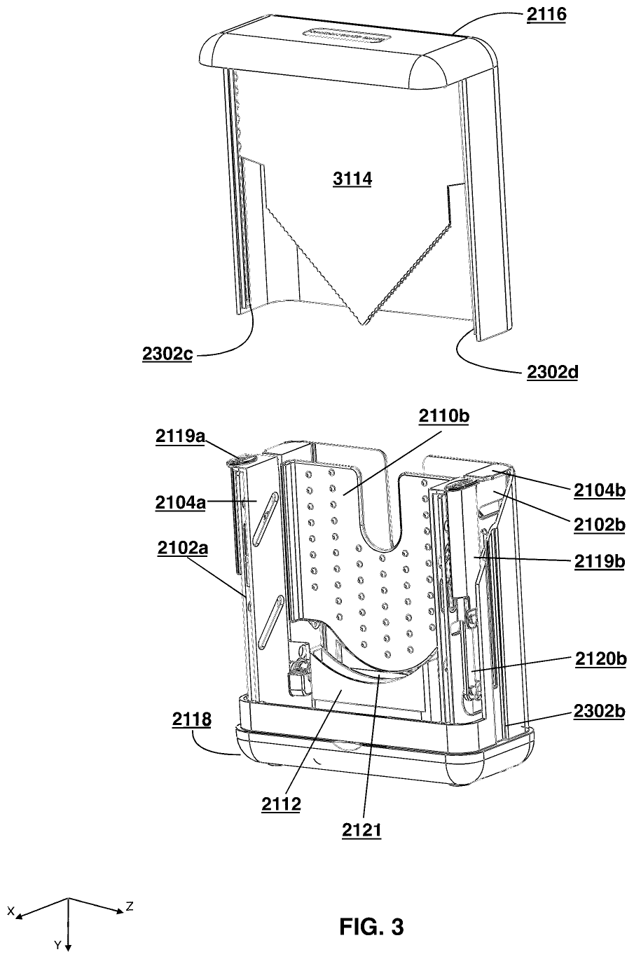

FIG. 3 shows a perspective view of a disengaged bagel slicing device, in accordance with some embodiments of the present disclosure. FIG. 3 depicts exterior vertical rails 2302a, 2302b (not all visible in FIG. 3), which are embedded in, and extend along the y-axis of, lower assembly 2118. As described above, when upper assembly 2116 engages with lower assembly 2118, interior vertical rails 2302c, 2302d of upper assembly 2116 fit into exterior vertical rails 2302a, 2302b of lower assembly 2118, which guides blade 3114 down a slicing path (e.g., along the y-axis of lower assembly 2118) towards the center of holding plate 2112.

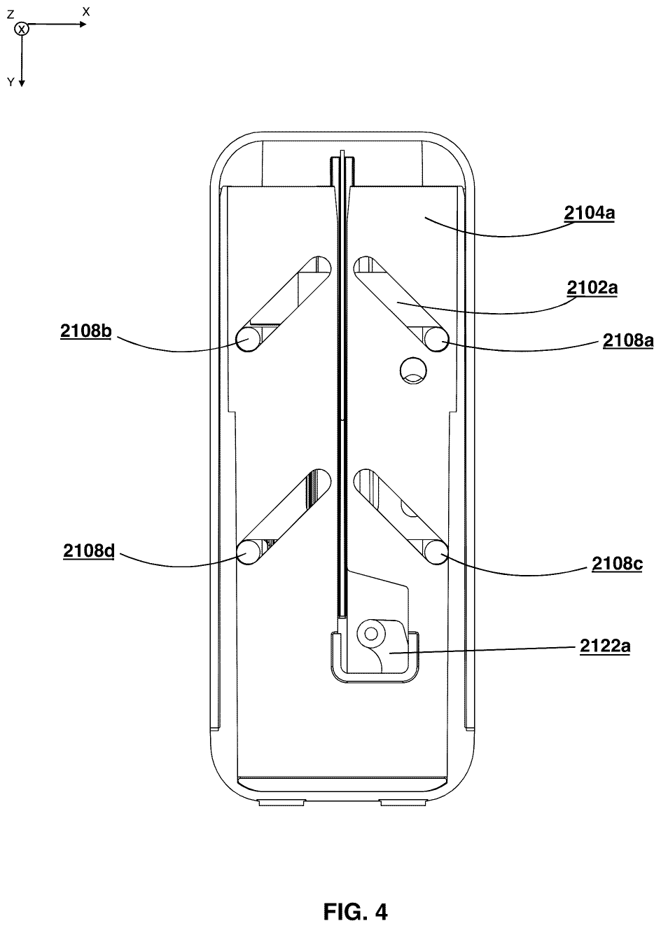

FIG. 4 shows a side section view of an engaged bagel slicing device along the device's x-y plane, in accordance with some embodiments of the present disclosure. In FIG. 4, pins 2108a-2108d extend from centering plates 2110a, 2110b through the slanted channels of inner plate 2104a and the horizontal channels of outer plate 2102a. It will be understood that centering plates 2110a, 2110b and pins 2108e-2108h extend out of the page through the slanted channels of inner plate 2104b and the horizontal channels of outer plate 2102b. In response to a user either depressing or releasing one or more actuators, pins 2108a-2108h, and accordingly centering plates 2110a, 2110b, move along the x-y plane of lower assembly 2118 to either separate to make room for a food item or to converge to center a food item along the y-z plane of lower assembly 2118 congruent with the center of holding plate 2112. In some embodiments, when centering the food item within lower assembly 2118, centering plates 2110a, 2110b may have a +/−one-sixteenth of an inch (about +/−0.16 centimeter) margin of error with respect to the center of holding plate 2112. Blade 3114 (not visible in FIG. 4), which extends along the y-z plane of lower assembly 2118, evenly bisects the curved nest of holding plate 2112 nearly to its base, ensuring a complete cut of a food item sitting on the holding plate 2112. In addition to blade 3114, centering plates 2110a, 2110b also extend along the y-z plane of the lower assembly.

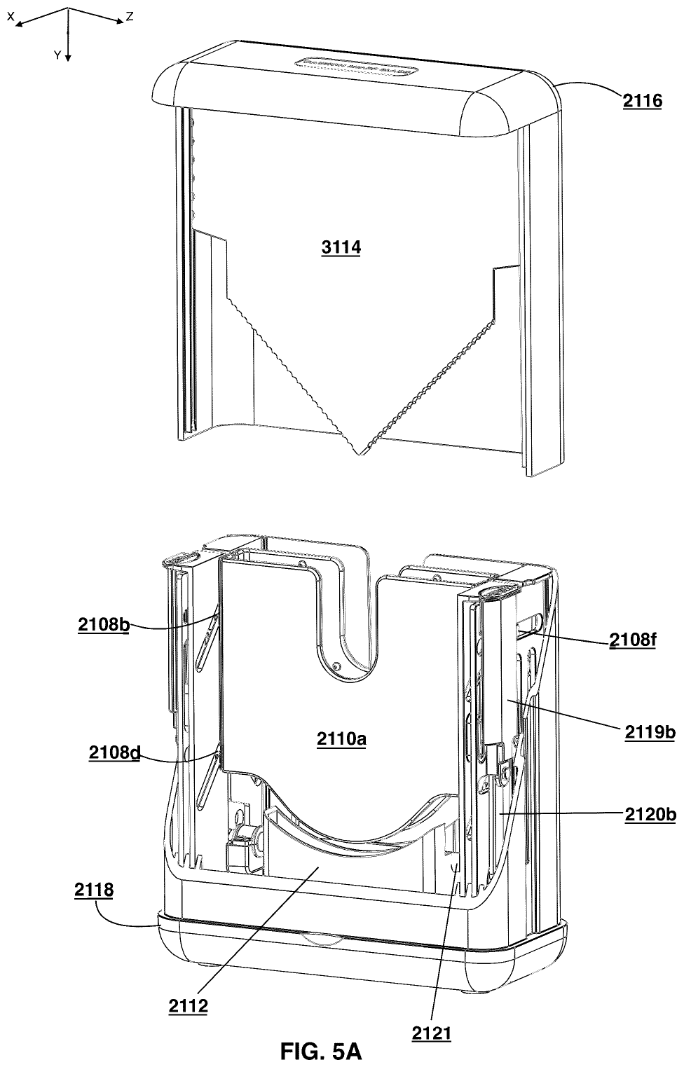

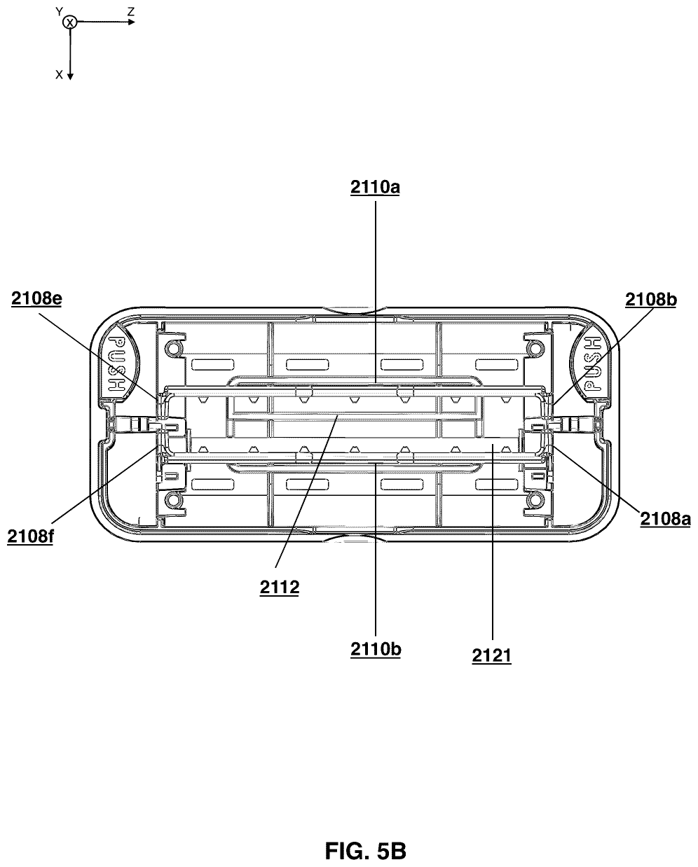

FIG. 5A shows a perspective view of a disengaged bagel slicing device, in accordance with some embodiments of the present disclosure, while FIG. 5B shows a top section view of the disengaged bagel slicing device along the device's x-z plane, in accordance with some embodiments of the present disclosure. In FIG. 5A, the plurality of pins 2108a-2108h (not all visible in FIG. 5A, FIG. 5B) are positioned in a default closed position, which, in some embodiments, is maintained by a spring mechanism within lower assembly 2118. The default closed position occurs when there is no food item in the lower assembly. FIG. 5B provides an aerial view of the corresponding position of the centering plates 2110a, 2110b when the plurality of pins 2108a-2108h are configured in the default closed position. It will be understood that in the default closed position the centering plates 2110a, 2110b are separated by a minimum distance of about 0.7 inch (about 1.778 centimeters).

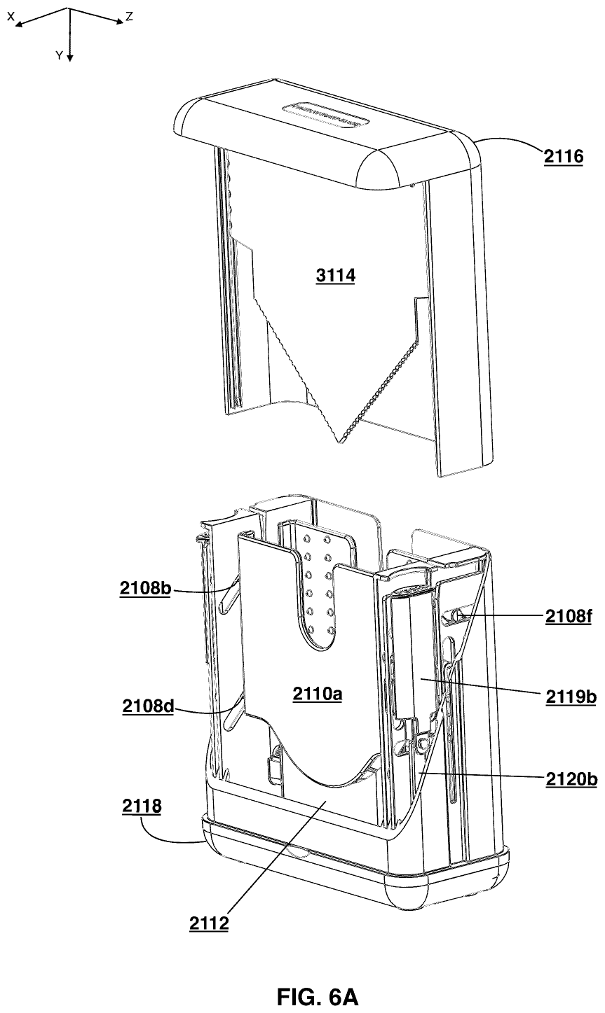

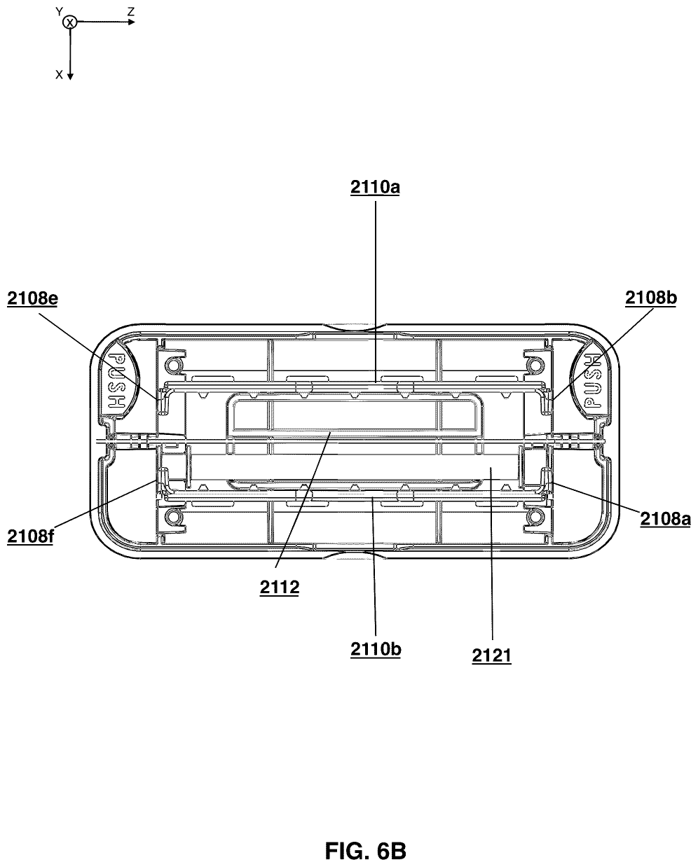

FIG. 6A shows a perspective view of an engaged bagel slicing device, in accordance with some embodiments of the present disclosure, while FIG. 6B shows a top section view of the engaged bagel slicing device along the device's x-z plane, in accordance with some embodiments of the present disclosure. In FIG. 6A, the plurality of pins 2108a-2108h (not all visible in FIG. 6A, FIG. 6B) are positioned in an intermediary position, which happens in response to a user depressing or releasing one or more actuators within lower assembly 2118. FIG. 6B provides an aerial view of the corresponding position of the centering plates 2110a, 2110b when the plurality of pins 2108a-2108h are configured in the intermediary position. It will be understood that in the intermediary position the centering plates 2110a, 2110b are separated by a distance between about 0.7 inch (about 1.778 centimeters) and about 2.3 inches (about 5.842 centimeters).

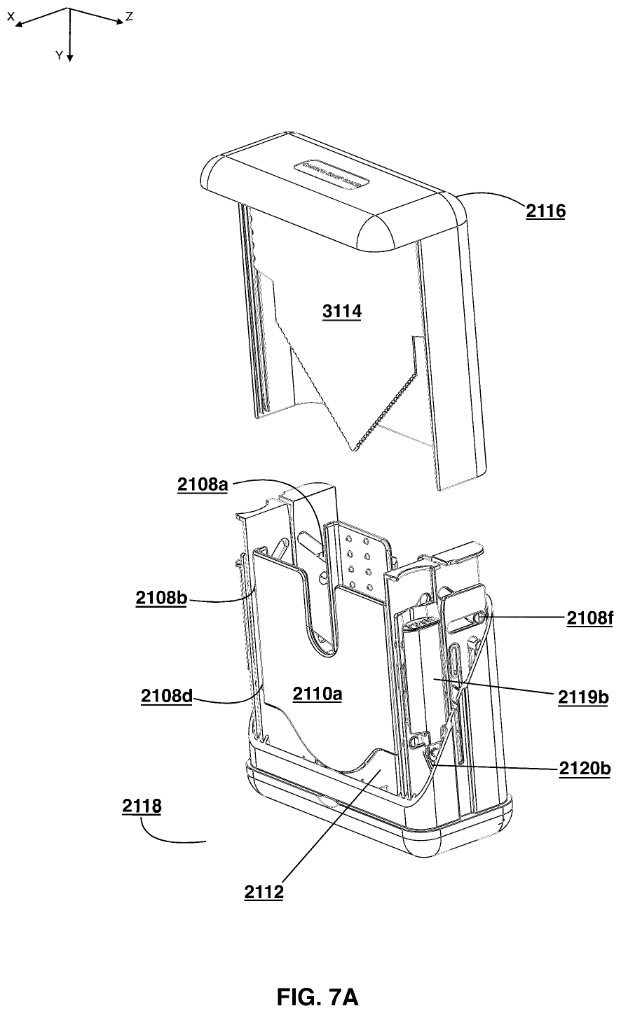

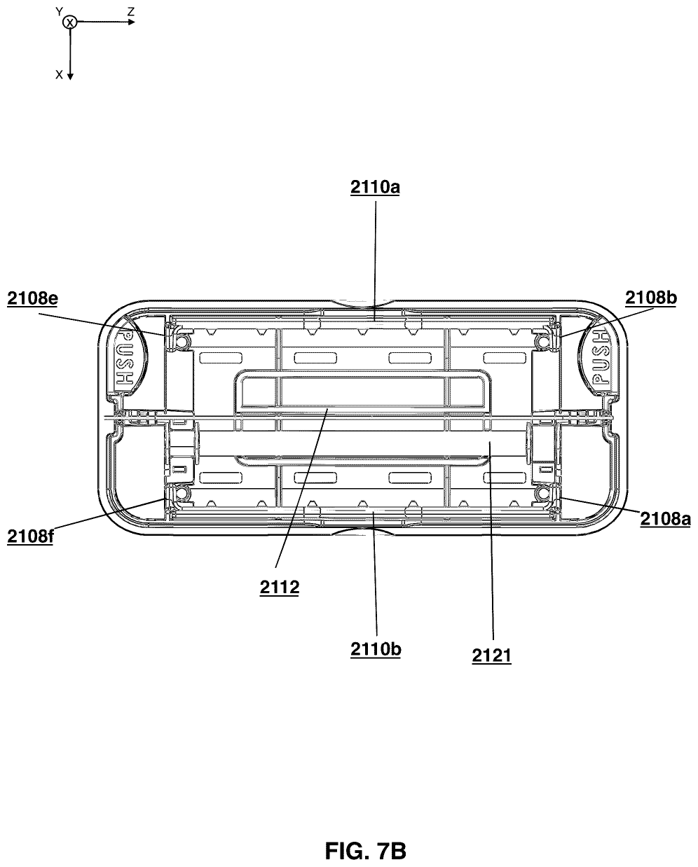

FIG. 7A shows another perspective view of an engaged bagel slicing device, in accordance with some embodiments of the present disclosure, while FIG. 7B shows a top section view of the engaged bagel slicing device along the device's x-z plane, in accordance with some embodiments of the present disclosure. In FIG. 7A, the plurality of pins 2108a-2108h (not all visible in FIG. 7A, FIG. 7B) are positioned in an end position, which happens in response to a user depressing one or more actuators within lower assembly 2118 to their limit. In some embodiments, a larger food item may be placed within lower assembly 2118, in which case the plurality of pins 2108a-2108h, and accordingly centering plates 2110a, 2110b, may retain the position depicted in each of FIG. 7A and FIG. 7B to fit and center the larger food item. FIG. 7B provides an aerial view of the corresponding position of the centering plates 2110a, 2110b when the plurality of pins 2108a-2108h are configured in the end position. It will be understood that in the end position the centering plates 2110a, 2110b are separated by a maximum distance of about 2.3 inches (about 5.842 centimeters).

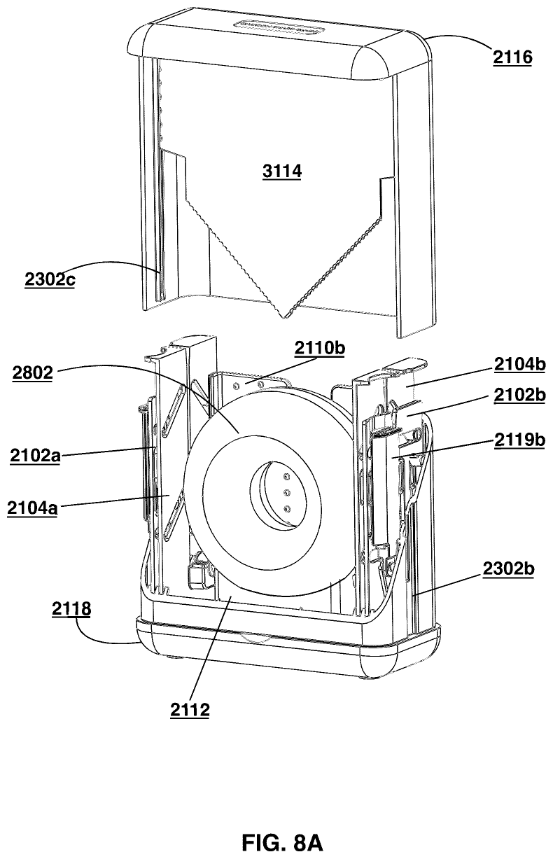

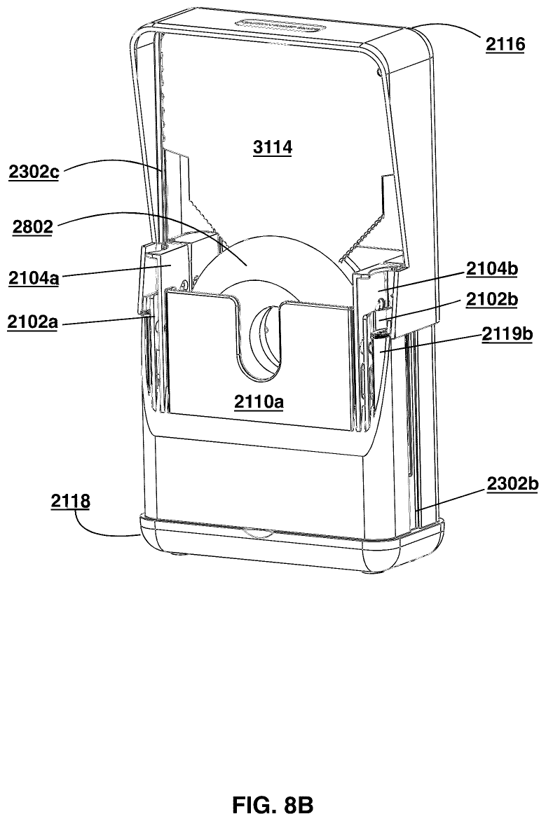

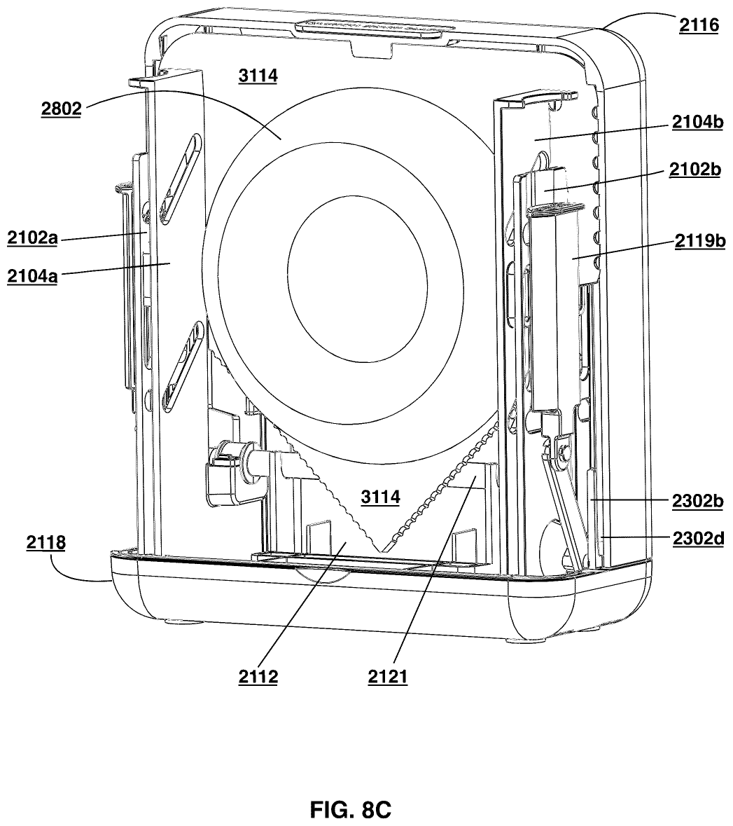

FIG. 8A shows a perspective view of a disengaged bagel slicing device, in accordance with some embodiments of the present disclosure, FIG. 8B shows a perspective view of a partially engaged bagel slicing device, in accordance with some embodiments of the present disclosure, and FIG. 8C shows a perspective view of a fully engaged bagel slicing device, in accordance with some embodiments of the present disclosure. In FIG. 8A, food item 2802 sits atop the curved nest of holding plate 2112 within lower assembly 2118, and centering plates 2110a, 2110b (not all visible in FIG. 8A, FIG. 8C) adjust to ensure food item is centered along the y-z plane of lower assembly 2118 congruent with the center of holding plate 2112. In FIG. 8B, as interior vertical rails 2302c, 2302d (not all visible in FIG. 8B, FIG. 8C) of upper assembly 2116 partially engage with exterior vertical rails 2302a, 2302b (not all visible in FIG. 8B, FIG. 8C) of lower assembly 2118, blade 3114 follows a slicing path down the y-axis of lower assembly 2118 towards the food item 2802 sitting atop holding plate 2112 (not visible in FIG. 8B). Blade 3114 has begun to bisect food item in this intermediary stage of the bagel slicing device. FIG. 8C depicts the full engagement between upper assembly 2116 and lower assembly 2118, as blade 3114 has completed the slicing path along exterior vertical rails 2302a, 2302b and, as a result, fully bisected food item 2802.

FIG. 9 shows a blade design for bisecting a food item within the lower assembly of the bagel slicing device. The serrated blade design disclosed herein may include multiple patterns and different blade serration shapes. In some embodiments, the blade may include an about 33° to about 45° knife edge. It will be understood that the serrated edge design is symmetrical. It will be understood that the dimensions of blade 2114 may be dependent on the package configuration of the bagel slicing device, so blade 2114 may be any suitable length, width, or height.

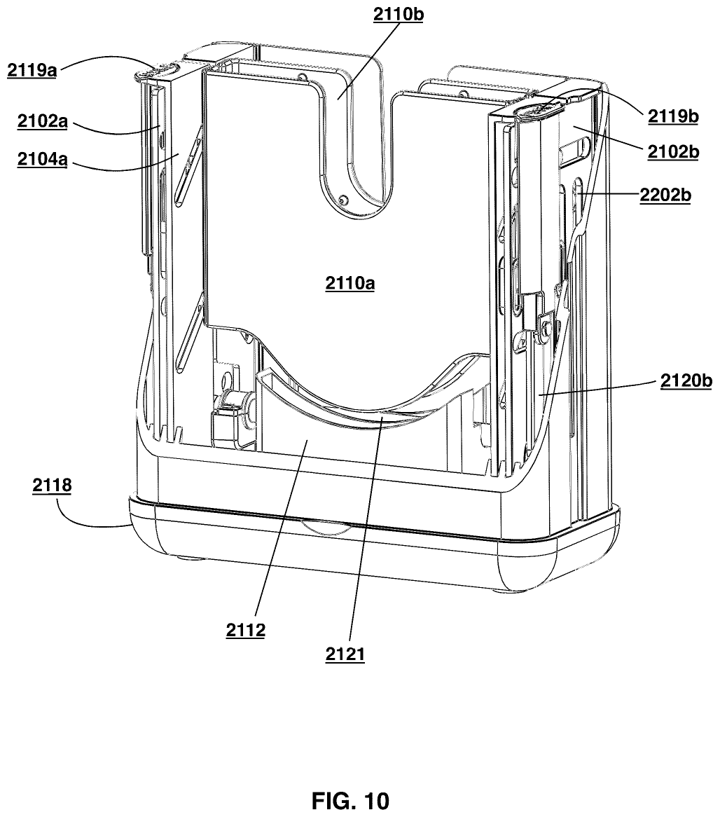

FIG. 10 shows a perspective view of a disengaged bagel slicing device, in accordance with some embodiments of the disclosure. In FIG. 10, like reference numerals indicate identical or functionally similar elements to those described hereinabove.

FIG. 11 shows another perspective view of a lower assembly of an engaged bagel slicing device, in accordance with some embodiments of the disclosure. In FIG. 11, like reference numerals indicate identical or functionally similar elements to those described hereinabove. In some embodiments, two vertical extension springs (not visible in FIG. 11) that load outer plates 2102a, 2102b, also attached to inner plates 2104a, 2104b, via spring retention studs 2204a-2204d (not all visible in FIG. 11), convert the vertical spring energy to horizontal energy through the horizontal channels to the slanted channels to compress centering plates 2110a, 2110b.

In certain embodiments, the blade 2114, as otherwise noted hereinabove, is substituted with an enhanced blade 3114, as depicted in the accompanying FIGS. 12 and 13. FIG. 13 provides a detailed view of FIG. 12.

In comparison to the blade 2114 described in the '855 application, the current blade 3114 incorporates a pair of notches 3114n positioned on the lateral sides of the blade 3114. This modification facilitates improved functionality of a slicer, e.g., the slicer referenced in the '855 application. Specifically, for example, the blade 3114, equipped with notches 3114n, mitigates undesirable contact with internal components of the slicer, such as adjacent sections of the lower assembly 2118. Additionally, for example, the blade 3114, featuring notches 3114n, enhances the release of vacuum during the separation of the upper and lower assemblies 2116 and 2118. Furthermore, for example, the blade 3114, with its notches 3114n, ensures a smoother slicing operation for items intended to be cut, including but not limited to food items such as bagels.

### Terminology

The terminology used herein is for the purpose of describing particular embodiments only and is not intended to be limiting of the disclosure.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The structures, devices, and methods discussed herein are intended to be illustrative and not limiting. One skilled in the art would appreciate that the actions of the processes discussed herein may be omitted, modified, combined, and/or rearranged, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and examples relating to some embodiments may be combined with any other embodiment in a suitable manner, done in different orders, or done in parallel. It should also be noted that the structures, devices, and methods described herein may be applied to, or used in accordance with, other structures, devices, and methods.

This specification discloses embodiments, which include, but are not limited to, the following items:

Item 1. An apparatus, comprising:
an upper assembly, comprising:
   an upper interior portion; and
   a blade affixed to the upper interior portion; and
a lower assembly, separable from the upper assembly, comprising:
   a holding plate configured to support a food item when placed within the lower assembly; and
   movable centering plates configured to secure the food item in a position that lies substantially in the center of the lower assembly to facilitate a substantially even bisection of the food item when the upper assembly engages with the lower assembly.

Item 2. The apparatus of item 1, wherein the centering plates are configured in a default closed position when the upper assembly is disengaged from the lower assembly, and wherein the lower assembly further comprises one or more actuators that, when depressed, cause the centering plates to separate from each other to define a space for the food item.

Item 3. The apparatus of item 2, wherein, in response to the food item being placed on the holding plate between the centering plates, releasing the one or more actuators causes the centering plates to apply substantially similar amounts of force on the food item to substantially center the food item.

Item 4. The apparatus of item 2, wherein a spring mechanism retains the default closed position of the centering plates at a minimum distance from each other.

Item 5. The apparatus of item 1, wherein the lower assembly further comprises a plurality of pins configured to couple the centering plates to a set of outer plates and a set of inner plates within the lower assembly, and wherein each of the plurality of pins resides within corresponding channels of the set of outer plates and the set of inner plates that facilitates movement of the centering plates when one or more actuators is depressed or released.

Item 6. The apparatus of item 5, wherein the movement of the centering plates comprises:
a movement of the plurality of pins along slanted channels of the set of inner plates;
a movement of the set of outer plates along the set of inner plates, via exterior vertical rails; and
a movement of the plurality of pins along horizontal channels of the set of outer plates.

Item 7. The apparatus of item 5, wherein each of the plurality of pins has a diameter of about ¼-inch (about 0.635 centimeter).

Item 8. The apparatus of item 1, wherein the lower assembly further comprises interior vertical rails, and wherein the blade is configured to engage with the interior vertical rails in the lower assembly and follow a slicing path that bisects the food item when the upper assembly engages with the lower assembly.

Item 9. The apparatus of item 1, further comprising a safety mechanism positioned at the bottom of the upper assembly, wherein the blade slides through an opening in the safety mechanism when the upper assembly engages with the lower assembly.

Item 10. The apparatus of item 9, wherein the blade is concealed behind the safety mechanism when the upper assembly is disengaged from the lower assembly.

Item 11. The apparatus of item 9, wherein the safety mechanism includes a guard.

Item 12. The apparatus of item 1, wherein the holding plate comprises a nest.

Item 13. The apparatus of item 1, wherein a distance between the centering plates has a range from about 1 inch (about 2.54 centimeters) to about 2 inches (about 5.08 centimeters).

Item 14. The apparatus of item 1, further comprising an opening along the perimeter of the upper assembly to enable cleaning of the blade and a cosmetic cover along the perimeter of the lower assembly to hide the movable centering plates and prevent pinch points.

Item 15. The apparatus of item 1, wherein the upper assembly and the lower assembly are comprised of at least one of a plastic, a metal, or an alloy.

Item 16. The apparatus of item 1, wherein the blade includes a serrated edge design with an about 45-degree knife edge and an about 50 percent cut depth, and wherein the serrated edge design is symmetrical.

Item 17. The apparatus of item 1, wherein the lower assembly includes at least one slot configured to receive insertion of an external cutting tool and configured to guide a cutting motion of the external cutting tool.

Item 18. The apparatus of item 1, wherein the movable centering plates configured to secure the food item in the position that lies substantially in the center of the lower assembly to facilitate the substantially even bisection of the food item when the upper assembly engages with the lower assembly are configured to align the food item within a margin of error of about +/−one-sixteenth of an inch (about +/−0.16 centimeter).

Item 19. A method, comprising:
depressing one or more actuators such that centering plates separate from each other within a lower assembly to define a space for a food item; and
in response to the food item being placed on a holding plate between the centering plates, releasing the one or more actuators to apply substantially similar amounts of force on the food item to substantially center the food item.

Item 20. The method of item 19, wherein the lower assembly further comprises a plurality of pins configured to couple the centering plates to a set of outer plates and a set of inner plates within the lower assembly, and wherein each of the plurality of pins resides within corresponding channels of the set of outer plates and the set of inner plates that facilitates movement of the centering plates when the one or more actuators is depressed or released.

Item 21. The method of item 20, wherein the movement of the centering plates comprises:
a movement of the plurality of pins along slanted channels of the set of inner plates;
a movement of the set of outer plates along the set of inner plates, via exterior vertical rails; and
a movement of the plurality of pins along horizontal channels of the set of outer plates.

Item 22. The method of item 21, wherein a spring mechanism retains a default closed position of the centering plates at a minimum distance from each other.

Item 23. The method of item 19, wherein the lower assembly includes at least one slot configured to receive insertion of an external cutting tool and configured to guide a cutting motion of the external cutting tool, the method comprising:
receiving insertion of the external cutting tool; and
guiding the cutting motion of the external cutting tool.

Item 24. The method of item 19, wherein the movable centering plates configured to secure the food item in the position that lies substantially in the center of the lower assembly to facilitate the substantially even bisection of the food item when the upper assembly engages with the lower assembly are configured to align the food item within a margin of error of about +/−one-sixteenth of an inch (about +/−0.16 centimeter).

Item 25. An apparatus, comprising:
an upper assembly, comprising:
   interior vertical rails; and
   a blade affixed to the upper assembly within the interior vertical rails; and
a lower assembly, separable from the upper assembly, comprising:
   a holding plate configured to support a food item when placed within the lower assembly;
   movable centering plates configured to secure the food item in a position that lies substantially in the center of the lower assembly to facilitate a substantially even bisection of the food item when the upper assembly engages with the lower assembly;
   exterior vertical rails containing a vertical slot down the center configured to receive an external cutting device for slicing food items; and
   a cam mechanism configured to activate the movable centering plates.

Item 26. The apparatus of item 25, wherein the centering plates are configured in a default closed position when there is no food item in the lower assembly, and wherein the lower assembly further comprises one or more actuators that, when depressed, cause the centering plates to separate from each other to define a space for the food item.

Item 27. The apparatus of item 26, wherein, in response to the food item being placed on the holding plate between the centering plates, releasing the one or more actuators causes the centering plates to apply substantially similar amounts of force on the food item to substantially center the food item.

Item 28. The apparatus of item 26, wherein a spring mechanism retains the default closed position of the centering plates at a minimum distance from each other.

Item 29. The apparatus of item 25, wherein the lower assembly further comprises a plurality of pins configured to couple the centering plates to a set of inner plates and outer plates within the lower assembly, wherein each of the plurality of pins resides within corresponding channels of the set of inner plates and the outer plates that facilitate movement of the centering plates when one or more actuators is depressed or released, and wherein, in response to a user depressing the one or more actuators, the actuators move up and down vertical slides of the outer plates and connect to linkage bars, which are connected to the cam mechanism, which connect the inner plates and the outer plates to activate the centering plates.

Item 30. The apparatus of item 29, wherein the movement of the centering plates comprises:
a movement of the plurality of pins along slanted channels of the set of inner plates;
a movement of the outer plates along the corresponding inner plate, via vertical slide alignments; and
a movement of the plurality of pins along horizontal channels of the outer plates.

Item 31. The apparatus of item 29, wherein each of the plurality of pins has a diameter of about ¼-inch (about 0.635 centimeter).

Item 32. The apparatus of item 25, wherein the lower assembly further comprises exterior vertical rails, and wherein the interior vertical rails of the upper assembly are configured to engage with the exterior vertical rails of the lower assembly such that the blade in the upper assembly follows a slicing path that bisects the food item when the upper assembly engages with the lower assembly.

Item 33. The apparatus of item 25, wherein the holding plate comprises a curved nest.

Item 34. The apparatus of item 25, wherein a distance between the centering plates has a range from about 0.125 inch (about 0.32 centimeters) to about 2.3 inches (about 5.842 centimeters).

Item 35. The apparatus of item 25, wherein the upper assembly and the lower assembly are comprised of at least one of a plastic, a metal, or an alloy.

Item 36. The apparatus of item 25, wherein the blade includes a serrated edge design with an about 33 degree to about 45 degree knife edge, and wherein the serrated edge design is symmetrical.

Item 37. The apparatus of item 25, wherein the lower assembly includes at least one slot configured to receive insertion of an external cutting tool and configured to guide a cutting motion of the external cutting tool.

Item 38. The apparatus of item 25, wherein the movable centering plates configured to secure the food item in the position that lies substantially in the center of the lower assembly to facilitate the substantially even bisection of the food item when the upper assembly engages with the lower assembly are configured to align the food item within a margin of error of about +/−one-sixteenth of an inch (about +/−0.16 centimeter).

Item 39. A method for an apparatus comprising an upper assembly having interior vertical rails, and a blade; and a lower assembly having a holding plate, movable centering plates, exterior vertical rails containing a vertical slot down the center configured to receive an external cutting device, and a cam mechanism configured to activate the movable centering plates, the method comprising:
depressing one or more actuators such that the centering plates separate from each other within the lower assembly to define a space for a food item; and
in response to the food item being placed on a holding plate between the centering plates, releasing the one or more actuators to apply substantially similar amounts of force on the food item to substantially center the food item.

Item 40. The method of item 39, wherein the lower assembly further comprises a plurality of pins configured to couple the centering plates to a set of inner plates and outer plates within the lower assembly, wherein each of the plurality of pins resides within corresponding channels of the set of inner plates and the outer plates that facilitate movement of the centering plates when the one or more actuators is depressed or released, and wherein, in response to a user depressing the one or more actuators, the actuators move up and down vertical slides of the outer plates and connect to linkage bars, which are connected to the cam mechanism, which connect the inner plates and the outer plates to activate the centering plates.

Item 41. The method of item 40, wherein the movement of the centering plates comprises:
a movement of the plurality of pins along slanted channels of the set of inner plates;
a movement of the outer plates along the corresponding inner plate, via vertical slide alignments; and
a movement of the plurality of pins along horizontal channels of the outer plates.

Item 42. The method of item 39, wherein a spring mechanism retains a default closed position of the centering plates at a minimum distance from each other.

Item 43. The method of item 39, wherein the lower assembly includes at least one slot configured to receive insertion of an external cutting tool and configured to guide a cutting motion of the external cutting tool, the method comprising:
receiving insertion of the external cutting tool; and
guiding the cutting motion of the external cutting tool.

Item 44. The method of item 39, wherein the movable centering plates configured to secure the food item in the position that lies substantially in the center of the lower assembly to facilitate the substantially even bisection of the food item when the upper assembly engages with the lower assembly are configured to align the food item within a margin of error of about +/−one-sixteenth of an inch (about +/−0.16 centimeter).

Item 45. A device for an upper assembly and a lower assembly for an item, the device comprising:
a blade movable via the upper assembly;
a holding plate movable via the lower assembly, wherein the holding plate is configured to hold the item;
a centering device engageable via movement of the upper assembly relative to the lower assembly, wherein the centering device is configured to hold and secure the item;
a cam mechanism configured to activate the movable centering plates; and
an actuator configured to receive a force and, via the cam mechanism, engage the centering device to receive the item, wherein the actuator is configured, upon release of the force, to engage and hold the item in a cutting position for cutting by the blade.

Item 46. The device of item 45 comprising a spring mechanism configured to hold the centering plates at a minimum distance apart.

Item 47. The device of item 45 comprising a plurality of pins configured to connect the centering plates to at least one of the upper assembly or the lower assembly and configured to permit movement of the centering plates.

Item 48. The device of item 45 comprising a guidance mechanism operatively coupled to the lower assembly, wherein the guidance mechanism is configured to permit the blade to cut the item.

Item 49. The device of item 45, wherein the centering device is configured to secure the item in a position that lies substantially in a center of the device to facilitate a substantially even bisection of the item, and wherein the centering device is configured to align the item within a margin of error of about +/−one-sixteenth of an inch (about +/−0.16 centimeter).

Item 50. A method of cutting an item with a device having an upper assembly and a lower assembly, the method comprising:
providing a blade movable via the upper assembly;
providing a holding plate movable via the lower assembly, wherein the holding plate is configured to hold the item;
providing a centering device engageable via movement of the upper assembly relative to the lower assembly, wherein the centering device is configured to hold and secure the item;
providing a cam mechanism configured to activate the movable centering plates; and
providing an actuator configured to receive a force and, via the cam mechanism, engage the centering device to receive the item, wherein the actuator is configured, upon release of the force, to engage and hold the item in a cutting position for cutting by the blade.

Item 51. The method of item 50 comprising providing a spring mechanism configured to hold the centering plates at a minimum distance apart.

Item 52. The method of item 50 comprising providing a plurality of pins configured to connect the centering plates to at least one of the upper assembly or the lower assembly and configured to permit movement of the centering plates.

Item 53. The method of item 50 comprising providing a guidance mechanism operatively coupled to the lower assembly, wherein the guidance mechanism is configured to permit the blade to cut the item.

Item 54. The method of item 50, wherein the centering device is configured to secure the item in a position that lies substantially in a center of the device to facilitate a substantially even bisection of the item, and wherein the centering device is configured to align the item within a margin of error of about +/−one-sixteenth of an inch (about +/−0.16 centimeter).

This description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus, comprising:
an upper assembly, comprising:
interior vertical rails; and
a blade affixed to the upper assembly within the interior vertical rails; and
a lower assembly, separable from the upper assembly, comprising:
a holding plate configured to support a food item when placed within the lower assembly;
movable centering plates configured to secure the food item in a position that lies substantially in the center of the lower assembly to facilitate a substantially even bisection of the food item when the upper assembly engages with the lower assembly;
exterior vertical rails containing a vertical slot down the center configured to receive an external cutting device for slicing food items; and
a cam mechanism configured to activate the movable centering plates.

2. The apparatus of claim 1, wherein the centering plates are configured in a default closed position when there is no food item in the lower assembly, and wherein the lower assembly further comprises one or more actuators that, when depressed, cause the centering plates to separate from each other to define a space for the food item.

3. The apparatus of claim 2, wherein, in response to the food item being placed on the holding plate between the centering plates, releasing the one or more actuators causes the centering plates to apply substantially similar amounts of force on the food item to substantially center the food item.

4. The apparatus of claim 2, wherein a spring mechanism retains the default closed position of the centering plates at a minimum distance from each other.

5. The apparatus of claim 1, wherein the lower assembly further comprises a plurality of pins configured to couple the centering plates to a set of inner plates and outer plates within the lower assembly, wherein each of the plurality of pins resides within corresponding channels of the set of inner plates and the outer plates that facilitate movement of the centering plates when one or more actuators is depressed or released, and wherein, in response to a user depressing the one or more actuators, the actuators move up and down vertical slides of the outer plates and connect to linkage bars, which are connected to the cam mechanism, which connect the inner plates and the outer plates to activate the centering plates.

6. The apparatus of claim 5, wherein the movement of the centering plates comprises:
a movement of the plurality of pins along slanted channels of the set of inner plates;
a movement of the outer plates along the corresponding inner plates, via vertical slide alignments; and
a movement of the plurality of pins along horizontal channels of the outer plates.

7. The apparatus of claim 1, wherein the lower assembly further comprises exterior vertical rails, and wherein the interior vertical rails of the upper assembly are configured to engage with the exterior vertical rails of the lower assembly such that the blade in the upper assembly follows a slicing path that bisects the food item when the upper assembly engages with the lower assembly.

8. The apparatus of claim 1, wherein the lower assembly includes at least one slot configured to receive insertion of an external cutting tool and configured to guide a cutting motion of the external cutting tool.

9. The apparatus of claim 1, wherein the movable centering plates configured to secure the food item in the position that lies substantially in the center of the lower assembly to facilitate the substantially even bisection of the food item when the upper assembly engages with the lower assembly are configured to align the food item within a margin of error of about +/−one-sixteenth of an inch (about +/−0.16 centimeter).

10. A method for an apparatus comprising an upper assembly having interior vertical rails, and a blade; and a lower assembly having a holding plate, movable centering plates, exterior vertical rails containing a vertical slot down the center configured to receive an external cutting device, and a cam mechanism configured to activate the movable centering plates, the method comprising:
depressing one or more actuators such that the centering plates separate from each other within the lower assembly to define a space for a food item; and
in response to the food item being placed on a holding plate between the centering plates, releasing the one or more actuators to apply substantially similar amounts of force on the food item to substantially center the food item.

11. The method of claim 10, wherein the lower assembly further comprises a plurality of pins configured to couple the centering plates to a set of inner plates and outer plates within the lower assembly, wherein each of the plurality of pins resides within corresponding channels of the set of inner plates and the outer plates that facilitate movement of the centering plates when the one or more actuators is depressed or released, and wherein, in response to a user depressing the one or more actuators, the actuators move up and down vertical slides of the outer plates and connect to linkage bars, which are connected to the cam mechanism, which connect the inner plates and the outer plates to activate the centering plates.

12. The method of claim 11, wherein the movement of the centering plates comprises:
a movement of the plurality of pins along slanted channels of the set of inner plates;
a movement of the outer plates along the corresponding inner plates, via vertical slide alignments; and
a movement of the plurality of pins along horizontal channels of the outer plates.

13. The method of claim 10, wherein a spring mechanism retains a default closed position of the centering plates at a minimum distance from each other.

14. The method of claim 10, wherein the lower assembly includes at least one slot configured to receive insertion of an external cutting tool and configured to guide a cutting motion of the external cutting tool, the method comprising:
receiving insertion of the external cutting tool; and
guiding the cutting motion of the external cutting tool.

15. The method of claim 10, wherein the movable centering plates configured to secure the food item in the position that lies substantially in the center of the lower assembly to facilitate the substantially even bisection of the food item when the upper assembly engages with the lower assembly are configured to align the food item within a margin of error of about +/−one-sixteenth of an inch (about +/−0.16 centimeter).

16. A device for an upper assembly and a lower assembly for an item, the device comprising:
a blade movable via the upper assembly;
a holding plate movable via the lower assembly, wherein the holding plate is configured to hold the item;
a centering device engageable via movement of the upper assembly relative to the lower assembly, wherein the centering device is configured to hold and secure the item;
a cam mechanism configured to activate the movable centering plates; and
an actuator configured to receive a force and, via the cam mechanism, engage the centering device to receive the item, wherein the actuator is configured, upon release of the force, to engage and hold the item in a cutting position for cutting by the blade.

17. The device of claim 16 comprising a spring mechanism configured to hold the centering plates at a minimum distance apart.

18. The device of claim 16 comprising a plurality of pins configured to connect the centering plates to at least one of the upper assembly or the lower assembly and configured to permit movement of the centering plates.

19. The device of claim 16 comprising a guidance mechanism operatively coupled to the lower assembly, wherein the guidance mechanism is configured to permit the blade to cut the item.

20. The device of claim 16, wherein the centering device is configured to secure the item in a position that lies substantially in a center of the device to facilitate a substantially even bisection of the item, and wherein the centering device is configured to align the item within a margin of error of about +/−one-sixteenth of an inch (about +/−0.16 centimeter).
